(19) United States
(12) Patent Application Publication
(10) Pub. No.: US 2026/0219561 A1
(43) Pub. Date: Jul. 30, 2026

(54) DEVICE FOR ARRANGING A PROJECTOR RELATIVE TO A SCREEN

(71) Applicant: Hanno Harland, Mölln (DE)

(72) Inventor: Hanno Harland, Mölln (DE)

(21) Appl. No.: 19/151,674

(22) PCT Filed: Jan. 24, 2024
(86) PCT No.: PCT/EP2024/051642

§ 371 Date: Jul. 29, 2025

(30) Foreign Application Priority Data
Jan. 30, 2023 (DE) 102023102113.3

(51) Int. Cl. G03B 21/10

(52) U.S. Cl. CPC G03B 21/10

(57) ABSTRACT

The invention relates to a device for arranging a projector in a position defined in all spatial directions relative to a screen, for projecting an image onto the screen by means of the projector, in the intended arrangement of the device, comprising:
a support device which is designed to mount an ultra-short-throw projector on its feet (in particular horizontally),
a movement device that is designed to move the support device between a storage position and a projection position, and
a screen rolled up around a horizontal axis, which can be rolled out from the rolled-up position by means of a guide device upward into a flat, essentially vertical projection position,
   wherein, in the storage position, the projector
is arranged below the rolled-up screen or
is rotated by 90° about a vertical axis relative to the projection direction of the device and is located in front of the rolled-up screen

### TECHNICAL FIELD

The invention relates to a device for arranging a projector, in particular an ultra-short-throw projector, in a position defined in all spatial directions relative to a screen in order to project an image via the projector onto the screen.

### BACKGROUND OF THE INVENTION

In order to experience the feeling of being at the cinema when watching a film at home, projectors that project an image onto a screen have been known for a long time, in addition to ever larger flat screens. Initially, projectors—like film projectors—required a projection distance. Now there are so-called ultra-short-throw projectors, whose required projection distance from the projection surface has been reduced to the mid double-digit cm range, allowing them to be placed directly below and in front of the screen. Their image processing and optics are designed so that the image projected onto the screen from below by such a projector is still distortion-free and, in particular, rectangular on the screen.

In order to integrate projectors into living environments, furniture has been developed with a screen rolled up around a horizontal axis that can be rolled out from the rolled-up position into a flat, vertical projection position. Unless the projector is simply placed on top of the furniture, such furniture sometimes has a support device designed to support an ultra-short-throw projector horizontally on its feet in such a way that the projector is positioned in relation to the screen in a position that is defined in all directions and suitable for projection onto the screen. Because ultra-short-throw projectors also require a certain projection distance, as mentioned above, such furniture requires a certain depth and overall volume in order to accommodate not only the projector but also the rolled-up screen.

### SUMMARY OF THE INVENTION

The present invention is based on the object of providing a device for arranging an ultra-short-throw projector relative to a screen that takes up as little space as possible and above which a continuous, uninterrupted cover plate, which completely covers the device in front of the screen in the direction of the projector, can be installed when the projector is not projecting an image. This object is achieved by a projector having the features of independent claims 1 or 6. Preferred embodiments are specified in the respective dependent claims.

The device according to the invention described below is used for arranging a projection device or projector, in particular an ultra-short-throw projector, in a position defined in all spatial directions relative to a screen for projecting an image onto the screen by means of the projector. The device comprises the following (in an arrangement as intended):
A support device is configured to mount an ultra-short-throw projector on its feet (in particular horizontally). This is particularly preferably a horizontal flat plate on which the projector can be placed.
A movement device is configured to move the support device between a storage position and a projection position. Thus, when a projector is placed on the support device, it can be moved by the movement device from the storage position into a projection position, which is particularly preferably defined in all spatial directions relative to the screen, in such a way that it satisfies the criteria that allow the projector to project a distortion-free image onto the screen.
A screen rolled up around a horizontal axis can be rolled out of its rolled-up position by means of a guide device into a flat (in particular essentially vertical) projection position.

According to the invention, the above-mentioned technical object is achieved by a device described above with the following two alternative features, namely that the projector in the storage position is
I.—below the rolled-up screen or
II.—rotated by 90° about a vertical axis relative to the projection direction of the device and arranged in front of the rolled-up screen.

In the first alternative of the invention, the projector is arranged in its storage position below the lowest height of the rolled-up screen. In this way, the device (when the projector is in its projection position in the device) hardly needs to be larger than the dimensions of the projector in its projection direction. The “projection direction of the device” is defined below as the inverse of the normal vector of the front plane of the rolled-out screen.

If the device according to the invention is a piece of furniture and this furniture is placed in a room so that the screen can be rolled out in front of a wall (essentially perpendicular), this extension in the projection direction of the projector (dimension of the furniture in the “projection direction of the device”) is the depth of the furniture in front of the wall—or, in other words, the distance by which the furniture protrudes from the wall into the room. To reduce this dimension as much as possible is thus achieved according to the invention, as defined in the last paragraph, and, as already stated there, in such a way that the device in this direction is “hardly larger than the dimension of the projector in this direction.” This is because the projector is fixed in size, so its dimensions naturally represent the minimum dimensions of the device in this direction, unless it is tilted in the storage position by means of a corresponding apparatus (e.g., by tilting) so that it takes up even less space in this direction.

It is particularly preferred that, in the storage position, the projector is arranged below the rolled-up screen so that, in the projection direction of the device, it is arranged directly adjacent to a vertical rear wall of the device, namely the rear wall to which the rolled-up screen is also directly adjacent. This applies in particular if the device is designed as a piece of furniture with a vertical rear wall, which in turn is intended to be placed directly against a wall of a room - or even screwed to such a wall so that the furniture according to the invention is then attached to the wall as a console, in front of which the screen can then be extended vertically upwards.

When the projector is in the storage position below the lowest height of the rolled-up screen, the movement device has the following features:
a carriage which, together with the support device, is movable from the storage position counter to the projection direction in front of the rolled-up screen by means of a first motor drive below the rolled-up screen, and
a lifting device which is configured to raise the support device into the projection position by means of the first or a second motor drive, preferably guided by means of a parallelogram gear.

It is then particularly preferred that the movement device has a first and a second carriage which, together with the support device, are movable from the storage position counter the projection direction in front of the rolled-up screen by means of a first motor drive located below the rolled-up screen. The support device is then mounted on the second carriage by means of a parallelogram gear of the lifting device, and the second carriage is mounted on the first carriage and the first carriage is mounted on a fixed element of the device, counter the projection direction against a stop, by means of at least one horizontal linear bearing (in particular by means of a pair of drawer pull-out rails). The first motor drive moves the second carriage relative to a fixed element of the device. And the support device is guided on each side in at least two parallel (in particular four not necessarily straight) upwardly directed guides (in particular elongated holes or grooves) fixed to the first carriage. In this way, the motor drive of the second carriage moves the first carriage until it reaches the stop, and then the continued motor drive of the second carriage pushes the support device upward in the guides by means of the rods of the parallelogram gear.

However, if a projector is smaller in its dimension transverse to its projection direction (width) than in its dimension (length) in the projection direction, the second alternative according to the invention allows a smaller extension in the height of the device by rotating the projector in the storage position by 90° about a vertical axis.

This allows the projector to be arranged in the storage position in the projection direction of the device in front of the rolled-up screen (particularly preferred directly adjacent to the rolled-up screen) and to remain unchanged in height relative to the projection position. This firstly allows the mechanism of the movement device to be designed somewhat less complex, namely to only drive rotation, and secondly, the height of the device can be reduced to the height of the projector (or the rolled-up screen, whichever is higher). In this direction, the device then only has dimensions slightly greater than the width of the projector plus the diameter of the rolled-up screen. It may even be possible to add the features of the first alternative to this second alternative—meaning that the projector is also positioned below the lowest height of the rolled-up screen when in the storage position. In this case, the device only has the width of the projector in this direction (which, by definition, is less than its length in its projection orientation for these types of projectors).

It is particularly preferred that the projector is arranged in its projection position with its upper side (and in particular with its upper-side projection device) at the same height or above the highest height of the rolled-up screen. This allows the projector to project the image to the lower edge of the screen without the front edge of a device for rolling up the screen or another contour forming the upper side of the device—in particular if the device is designed as furniture—getting in the way and obscuring the projection.

If (according to the second alternative) the projector is rotated by 90° about a vertical axis in the storage position, it is preferable that the support device is movable by 90° about a vertical axis by means of a motorized drive and that the support device guides a drawer by means of a guide.

If (according to the second alternative) the projector is rotated by 90° about a vertical axis in the storage position, it is particularly preferred that
the support device is arranged so as to be radially displaceable on a carousel device which is movable by means of a motor drive by 90° about a vertical axis, and that
the carousel device guides a drawer by means of a first guide and that
the support device is guided by the drawer by means of a second guide in such a way that
   i. the motor drive of the carousel device pushes the drawer out of the storage position into the projection position by means of the first guide and, in doing so,
   ii. the drawer pushes the support device radially outward relative to the carousel device by means of the second guide.

It is particularly preferred that the device is designed as a piece of furniture, in particular as a sideboard, with a housing and the slides therein as drawer pull-outs.

### BRIEF DESCRIPTION OF THE FIGURES

Further aspects, features, and technical advantages of the invention are described below with reference to the figures. The figures show embodiments of the invention in which the examples shown therein and described here are also individual, detached from the respective embodiment shown, and are in accordance with the invention, namely

FIG. 1a-c schematic side views of a device according to the invention in movement phases between the storage and projection positions,

FIG. 2a-e schematic top views of an alternative device according to the invention in movement phases between the storage and projection positions, as well as schematic side views of the storage and projection positions, and

FIG. 3a-e schematic top views of yet another alternative device according to the invention in movement phases between the storage and projection positions, as well as schematic side views of the storage and projection positions.

### DETAILED DESCRIPTION OF EXEMPLARY EMBODIMENTS

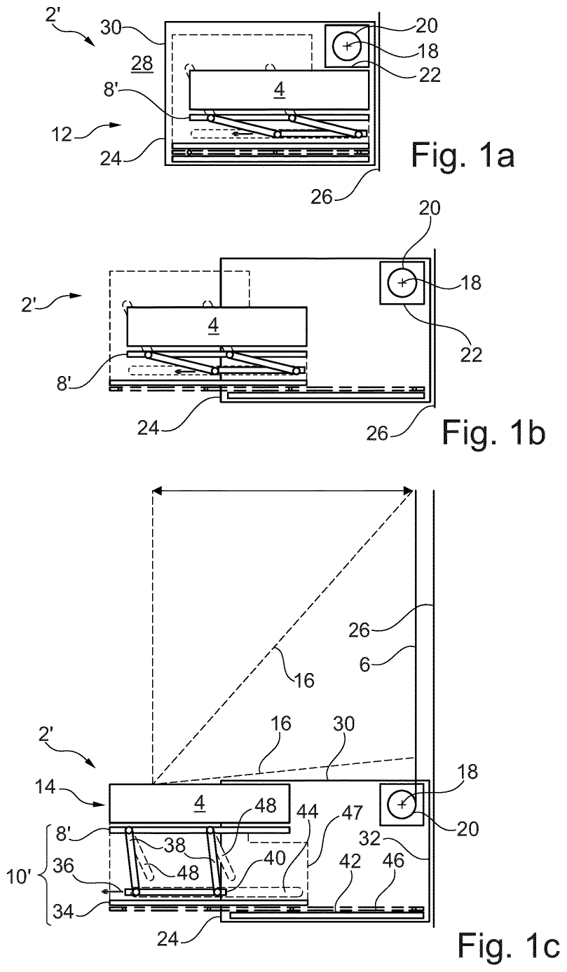

Each of the devices 2 according to FIGS. 1 to 3 serves to arrange an ultra-short-throw projector 4 in a position defined in all spatial directions relative to a screen 6, namely for projecting an image onto the screen by means of the projector. Each of the devices 2 according to FIGS. 1 to 3 comprises the following (in the intended arrangement as shown):
A support device 8 is configured to support the ultra-short-throw projector 4 horizontally on its feet. This is a horizontal flat plate 8 on which the projector 4 can be placed and is arranged as shown.
A movement device 10 is configured to move the support device 8 between a storage position 12 and a projection position 14. When a projector 4 is placed on the support device 8, it can be moved by means of the movement device 10 from the storage position 12 to a projection position 14, which is particularly preferably defined in all spatial directions relative to the screen 6, in such a way that the projection position 14 satisfies the criteria that allow the projector 4 to project a distortion-free image onto the screen (in accordance with the beam path 16).
A screen 6 rolled up around a horizontal axis 18 can be rolled out from its rolled-up position 20 by means of a guide device (not shown) upward into a flat vertical projection position 6.

In the device 2′ according to FIG. 1, the projector 4 is arranged in the storage position 12 as a first alternative below the lowest height of a housing 22 of the rolled-up screen 20 (FIG. 1a). In this way, the device 2′ does not need to have a greater extent in the projection direction of the projector 4 in its projection position 14 (in all side views to the right) than the dimension of the projector in its projection direction—i.e., in FIG. 1, its length from left to right.

The devices 2 shown are a piece of furniture 24 with a box-shaped outer contour 24, which is placed at a room wall 26 so that the screen 6 can be rolled out vertically in front of the wall 26. The “extension in the projection direction of the projector” (the dimension of the furniture 24 in the “projection direction of the device 2”) is the “depth” of the furniture 24 in front of the wall 26—or, in other words, the distance by which the furniture 24 protrudes from the wall 26 into the room 28. This dimension is reduced as much as possible by arranging the projector 4 in the storage position 12 below the lowest height of the housing 22 of the rolled-up screen 20 (FIG. 1a). This means that the device 2′does not need to be significantly larger in this direction than the dimensions of the projector in this direction (in FIG. 1, the dimensions of the piece of furniture 24 and the projector 4 from left to right). Since the projector 4 is, of course, fixed in its size, its size naturally represents the minimum dimensions of the device 2 in this direction.

In addition, a continuous, uninterrupted cover plate 30 may be mounted above the device 2 in front of the screen 6 in the direction of the projector (in its projection position 14), which completely covers the device when the projector is not projecting an image and is therefore in its storage position 12 (FIGS. 1a, 2d, 3d). This is because the projector is moved into its projection position 14 by means of the movement device 10 against the projection direction in front of the rest of the device, and there, in the projection position 14, the projector 4 is arranged with its upper side 28 (and in particular with its upper-side projection device) approximately at the same height, slightly above the highest height of the rolled-up screen 20 (FIGS. 1c, 2e, and 3e). This allows the projector 4 to project the image to the lower edge of the screen, without a front edge of a device 22 for rolling up the screen or another contour 24 forming the upper side of the device 2—in particular if the device 2 is designed as furniture 24—would be getting in the way and obscuring the projection.

When the projector 4 is arranged below the housing 22 of the rolled-up screen 20 in the storage position according to FIG. 1a, it is advantageous in terms of space saving if the projector 4 is arranged directly adjacent to a vertical rear wall 32 of the device 2, to which the rolled-up screen 20 is also arranged directly adjacent in its housing 22. With the vertical rear wall 32, the device 2 can therefore be placed directly against a wall 26 of a room 28—or even screwed to such a wall 26, so that the 24 furniture is then attached to the wall 26 as a console 24, in front of which the screen 6 is then extendable vertically upwards (FIGS. 1c, 2e and 3e).

In the first alternative described above, in which the projector 4 is arranged below the lowest height of the rolled-up screen 20, 22 in the storage position 12, the movement device 10′ serves to lift a projector 4 from the storage position 12 into the projection position 14.

More precisely, the movement device 10′ has a first carriage 34 and a second carriage 40 which, together with the support device 8′, can be moved by means of the motor drive 36 below the rolled-up screen 20 from the storage position 12 against the projection direction in front of the rolled-up screen 20. The support device 8′ is then mounted on the second carriage 40 by means of the parallelogram gear 38 of the lifting device, and the second carriage 40 is mounted on the first carriage 34, which first carriage 34 itself is mounted on a fixed element 42 of the device (the base plate 42 of the piece of furniture 24)—and the first carriage 34 is mounted against a stop (not shown) on the fixed element 42 in the opposite direction to the projection direction—by means of at least one horizontal linear bearing (in a lateral longitudinal groove 44 or by means of a pair of drawer pull-out rails 46). The motor drive 36 (not shown—symbolized by the vector 36 of the translational drive force, for example by means of a spindle drive) moves the second carriage 40 relative to the fixed element 42 of the device. And the support device 8′ is guided on both sides in at least two parallel, arcuate, upwardly directed guides 48 (slots or grooves) arranged in side walls 47 on the first carriage 34. In this way, the motor drive 36 of the second carriage 40 moves the first carriage 34 to the position of the first carriage 34 shown in FIG. 1c until it reaches the stop (not shown), and then the continued motor drive 36 of the second carriage 40 pushes the support device 8′ upward in the guides 48 by means of the rods of the parallelogram gear 38.

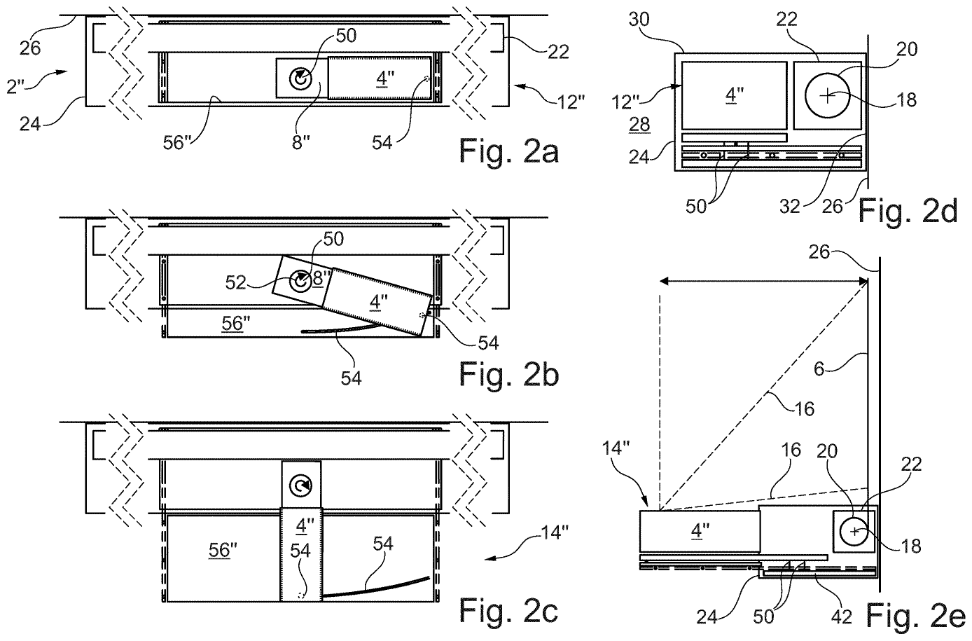

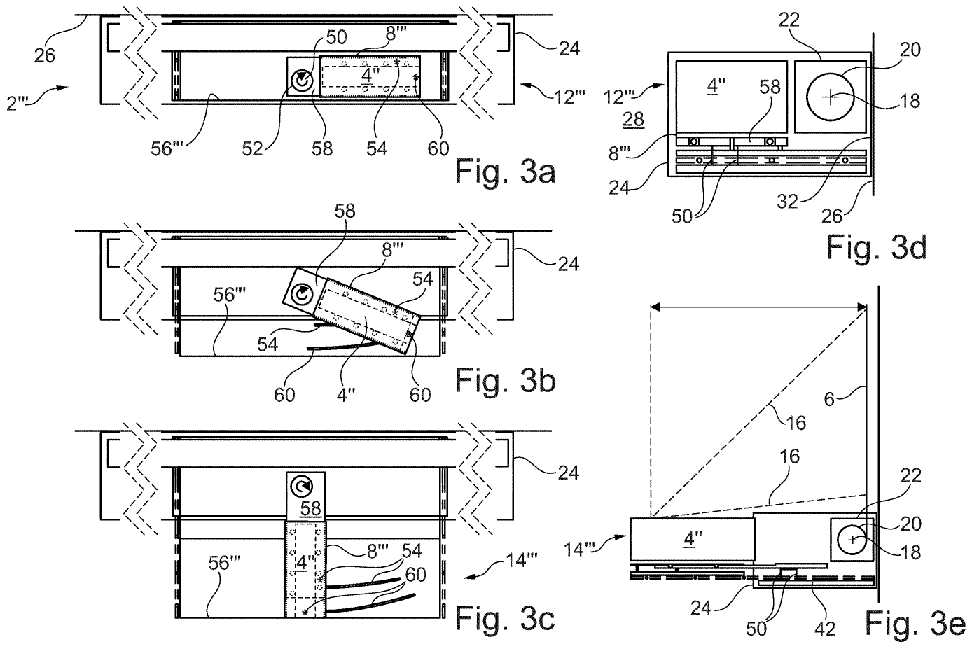

However, if a projector 4″ is smaller in its dimension transverse to its projection direction (width) than in its dimension (length) in the projection direction, the following second alternative according to FIGS. 2 and 3 of the device 2″ and 2′″, which is designed for such narrow projectors, to have an even smaller extension in this direction, in the projection direction of the device—the distance by which the device 2″, 2′″ “protrudes from the wall 26 into the room 28”:

Here, the projector 4″ is rotated in the storage position by 90° about a vertical axis 50 (FIGS. 2 a, 2d, 3a, and 3d) with respect to the projection position in which the projector 4″ is turned out from under the rest of the device (FIGS. 2e, 3e). This allows a continuous, uninterrupted cover plate 30 to be mounted above the device 2″ (and 2′″, as shown in FIG. 3—see below) in front of the screen 6 in the direction of the projector (in its projection position 14), which completely covers the device when the projector is not projecting an image and is therefore in its storage position 12 (FIGS. 1a, 2d, 3d).

Here, the (narrow) projector 4″ is in the storage position 12″ (FIGS. 2d and 3d) in front of the rolled-up screen 20 (particularly preferably directly adjacent to the rolled-up screen 20, more precisely in front of its housing 22 (in particular, its height is unchanged with respect to the projection position 14″—which allows the mechanism of the movement device to be designed somewhat less complex, namely only driving the rotation 50). Thus, the device 2″, 2′″ in this direction has the dimension of the width of the projector 4″ plus the diameter of the rolled-up screen 20 (and its housing 22).

In variant 2″, the (narrow) projector 2″ is rotated by 90° around a vertical axis 50 in the storage position—because the support device 8″ is movable by means of a motor drive (only the rotation vector 52 is shown) relative to a fixed element of the device, the base 42 of the sideboard 24, by 90° about a vertical axis 50 (and the support device 8″, 8′″ guides a drawer 56″ by means of a guide 54.

A variant of the device 2″ for narrow projectors described in FIG. 2 is shown in FIG. 3. This allows a greater projection distance and/or a narrower drawer 56—and, unlike the device described in the last paragraph, it is characterized in that
the support device 8′″ is arranged so that it is radially displaceable on a carousel device 58, which is movable by 90° around a vertical axis 50 by means of a motor drive 52, and that
the carousel device 58 guides a drawer 56′″ by means of a first guide 54, and that
the support device 8′″ is guided by means of a second guide 60 from the drawer 56′″ in such a way that
   i. the motor drive 52 of the carousel device 58 pushes the drawer 56′″ out of the storage position 12′″ into the projection position 14′″ by means of the first guide 54 and, in doing so,
   ii. the drawer 56′″ pushes the support device 8′″ radially outwards relative to the carousel device 58 by means of the second guide 60.

1. A device for arranging a projector in a position defined in all spatial directions relative to a screen, for projecting an image onto the screen by means of the projector, in the intended arrangement of the device, comprising:
a support device configured to support an ultra-short-throw projector on its feet (in particular horizontally),
a movement device configured to move the support device between a storage position and a projection position, and
a screen rolled up around a horizontal axis, which screen can be rolled out from the rolled-up position by means of a guide device upward into a flat, essentially vertical projection position,
wherein
in the storage position, the projector is arranged below the rolled-up screen.

2. The device according to claim 1, characterized in that in the storage position, the projector is arranged below the rolled-up screen and, in the projection direction, directly adjacent to a vertical rear wall of the device, to which the rolled-up screen is also directly adjacent.

3. The device according to claim 1, characterized in that the movement device comprises:
a carriage which, together with the support device, is movable by means of a first motor drive below the rolled-up screen from the storage position against the projection direction in front of the rolled-up screen, and
a lifting device which is arranged by means of the first or a second motor drive to lift the support device into the projection position.

4. The device according to claim 1, characterized in that the lifting device comprises a parallelogram gear.

5. The device according to claim 4, characterized in that the movement device has a first and a second carriage which, together with the support device, are movable by means of a first motor drive below the rolled-up screen from the stowed position against the projection direction in front of the rolled-up screen, wherein
the support device is mounted on the second carriage by means of a parallelogram gear as a lifting device, and
the second carriage is mounted on the first carriage and the first carriage is mounted on a fixed element of the device, against the projection direction against a stop, by means of at least one horizontal linear bearing (in particular by means of a pair of drawer pull-out rails), and wherein
the first motor drive displaces the second carriage relative to a fixed element of the device and the support device is guided in at least two parallel (in particular four not necessarily straight) upwardly directed mounted on the first carriage, so that the motor drive of the second carriage moves the first carriage against the stop and then the continued motor drive of the second carriage pushes the support device upward in the guides by means of the rods of the parallelogram gear.

6. A device for arranging an ultra-short-throw projector in a position defined in all spatial directions relative to a screen, designed for a projector whose width transverse to its projection direction is smaller than its length in the projection direction, for projecting an image onto the screen by means of the projector, in the intended arrangement of the device, comprising:
a support device which is designed to mount an ultra-short-throw projector on its feet (in particular horizontally),
a movement device which is designed to move the support device between a storage position and a projection position, and
a screen rolled up around a horizontal axis, which can be rolled out from the rolled-up position by means of a guide device upward into a flat, essentially vertical projection position,
wherein
in the storage position, the projector is rotated by 90° about a vertical axis relative to the projection direction of the device and is arranged in front of the rolled-up screen.

7. The device according to claim 6, characterized in that in the storage position, the projector is arranged directly adjacent to the rolled-up screen in the projection direction.

8. The device according to claim 6, characterized in that
the support device is arranged so as to be radially displaceable on a carousel device which is movable by 90° about a vertical axis by means of a motor drive, in that
the carousel device guides a drawer by means of a first guide, and in that
the support device is guided by a second guide from the drawer in such a way that
i. the motor drive of the carousel device pushes the drawer out of the storage position into the projection position by means of the first guide, and
ii. the drawer pushes the support device radially outwards relative to the carousel device by means of the second guide.

9. The device according to claim 6, characterized in that the device is designed as a sideboard with a housing and the carriages therein as drawer pull-outs.

10. The device according to claim 1, characterized in that the device is designed as a sideboard with a housing and the carriages therein as drawer pull-outs.
